(19) United States
(12) Patent Application Publication
(10) Pub. No.: US 2023/0392946 A1
(43) Pub. Date: Dec. 7, 2023

(54) METHOD FOR SELECTING INFORMATION ITEMS TO BE TRANSMITTED TO AN ON-BOARD SYSTEM OF A VEHICLE AND ASSOCIATED DEVICE

(71) Applicant: Renault S.A.S., Boulogne Billancourt (FR)

(72) Inventors: Colin AUBE, Antibes (FR); Cédric BONDIER, Grasse (FR); Eric PERRAUD, Plaisance du Touch (FR); Stéfania SESIA, Roquefort les pins (FR)

(73) Assignee: Renault S.A.S., Boulogne Billancourt (FR)

(21) Appl. No.: 18/249,212

(22) PCT Filed: Sep. 23, 2021
(86) PCT No.: PCT/EP2021/076227

§ 371 Date: Apr. 14, 2023

(30) Foreign Application Priority Data
Oct. 16, 2020 (FR) 20 10596

(51) Int. Cl. G01C 21/36

(52) U.S. Cl. CPC G01C 21/3676; G01C 21/3682

(57) ABSTRACT

A device or method selects information items from a plurality of information items which are emitted by transmitters located at a distance from a vehicle, with a view to transmitting the selected information items to at least one system on board the vehicle. The method includes: a) estimating the position of each information item on a map of movement paths in accordance with the absolute position of the information received, b) determining at least one place of interest at which to position the information items which the at least one on-board system wishes to have transmitted, c) selecting, from the information items received, the ones to transmit to the on-board system in accordance with their estimated position on the map and the place of interest.

### TECHNICAL FIELD OF THE INVENTION

The present invention generally relates to systems allowing a motor vehicle to communicate with the outside world. It more specifically relates, here, to selection of information items from among a plurality of information items received at a time t from senders located at distance from the vehicle, with a view to transmitting the selected information items to at least one driver assistance system located on board the vehicle.

The invention more particularly relates to a method for selecting information items and to a device for selecting information items.

The invention is particularly advantageously applicable to selection of information items received by a vehicle within the context of the technology commonly called “V2X”, which encompasses technologies in which the senders communicating with the vehicle are other vehicles (V2V), in which the senders communicating with the vehicle are pieces of road infrastructure (V2I), in which the senders communicating with the vehicle are network transmitters (V2N) and in which the senders communicating with the vehicle are pedestrians (V2P).

### PRIOR ART

Many vehicles today are equipped with on-board driver assistance systems, which make it possible to assist the driver while he or she is driving, whether in dangerous driving situations or simply to improve driving comfort. For example, the following on-board systems are known: navigation systems, which help the driver to follow a route to get from point A to point B; advanced driver assistance systems (ADAS); or even the dashboard, which displays alerts while the vehicle is being driven. To operate effectively, on-board systems must probe and analyze the environment of the vehicle, whether it be close by or further off. To this end, the vehicle is equipped with physical sensors that collect information on the surroundings of said vehicle. To further improve knowledge of its environment, the vehicle may also be equipped with V2X technology, by virtue of which it receives messages from senders located at distance from it, for example from other vehicles (V2V), from road infrastructure (V2I), from a network (V2N) or even from other road users such as pedestrians (V2P). The messages received from these senders contain various information items such as: the absolute position (in GPS coordinates) of the sender, the reliability of this position, the speed of movement of the sender, the acceleration of the sender and/or its direction of movement, or even hazards that the sender has encountered or created during its movement (slippery road, dangerous bend, accident, traffic congestion, etc.). It is thus estimated that, with deployment of V2X technology in an increasing number of vehicles, the number of information items that will eventually be received per second in a vehicle will be such that it will become necessary to select the received information items so as to transmit to each on-board system only those that are useful to it, as otherwise there will be a risk of its operation saturating and slowing down.

### PRESENTATION OF THE INVENTION

In this context, the present invention provides a method for selecting information items that makes it possible to eliminate or deprioritize the information items least useful to the on-board system, in order to make it easier for this on-board system to process information items and to prevent its operation from being slowed down. More particularly, according to the invention, a method such as defined in the introduction is provided, in which method provision is made to:
a) estimate the position of each received information item in a traffic-lane map depending on the absolute position of said information item received at the time t,
b) determine at least one place of interest in which the information items that said at least one on-board system wishes to see transmitted as a priority must be positioned,
c) select, among the received information items, those to be transmitted to the on-board system, depending on their estimated position in the map established in step a) and on the place of interest determined in step b).

By traffic lane what is meant is any type of road or path capable of being taken by a vehicle, whether motorized or not, or by a pedestrian.

Thus, by virtue of the invention, information items located outside the place of interest are not transmitted to the on-board system, or are considered by this system not to be a priority. This makes it possible to reduce the number of information items to be processed by the on-board system, and to preserve only the most relevant information items.

The following are other advantageous and non-limiting features of the method according to the invention, which features may be implemented individually or in any technically possible combination:
in step a), the position of each information item received at the time t is estimated in the map using a location procedure chosen from among a simplified procedure with rapid execution or a complex procedure with slower execution, the location procedure being chosen depending on a density value of the network of traffic lanes along a reference route of the vehicle;
the choice of the location procedure is further made depending on the statistical error associated with the absolute position of the information item received at the time t;
the simplified location procedure comprises an orthogonal projection of the absolute position of the received information item into each traffic lane, and selection of the shortest orthogonal projection to estimate the position of the received information item in the map;
the complex location procedure determines the traffic lane into which it is appropriate to project the absolute position of the information item received at the time t, on the basis, on the one hand, of a relatively extensive region of the map, and, on the other hand, of a relatively high number of past positions adopted by the information item received at times preceding the time t;
the complex location procedure comprises a parametrizing step during which are parametrized the size of the region of the map and the number of past positions to be considered, depending on the statistical error associated with the absolute position of the information item received at the time t;
the complex location procedure further comprises an initializing step, during which it is chosen, for each of the past positions adopted at one of the times preceding the time t, whether said position to be considered is the absolute position or the estimated position in the map of the information item received at said time preceding the time t, the choice being made depending on the reliability associated with the estimated position;
in step b), the place of interest is delineated by a spatial filter which indicates the traffic-lane portions to be considered depending, on the one hand, on the position of the vehicle at a time t, and, on the other hand, on a reference route of the vehicle at the time t;
the spatial filter comprises a list of traffic-lane segments; —spatial filter comprises:

a reference position in the map,

a maximum distance on the reference route of the vehicle, measured from the reference position,

the degree of adjacent traffic lanes to be considered, and

possibly, a maximum distance, in the adjacent traffic lanes, measured from the reference position.

The invention also provides a device for selecting information items from among a plurality of information items received at a time t from senders located at distance from a vehicle, with a view to transmitting the selected information items to a driver assistance system located on board the vehicle, comprising:
a memory unit configured to store a map of traffic lanes, at least one place of interest in which the information items to be transmitted as a priority to the on-board system must be positioned, and the absolute position of the information item received at the time t,
a control unit configured to estimate the position of each received information item in the map and to select the received information items to be transmitted as a priority to the on-board system depending on the estimated position of said received information items in the map and on the place of interest stored in the memory unit.

### DETAILED DESCRIPTION OF THE INVENTION

The description that follows with reference to the appended drawings, which are given by way of non-limiting example, will make it easy to understand of what the invention consists and how it may be implemented.

In the appended drawings:

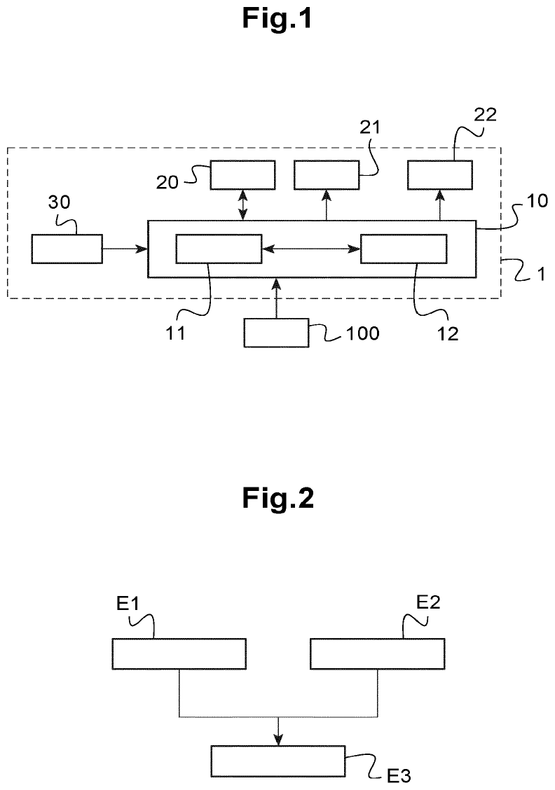

FIG. 1 is a block diagram of a device according to the invention;

FIG. 2 is a diagram of the main steps of a method according to the invention;

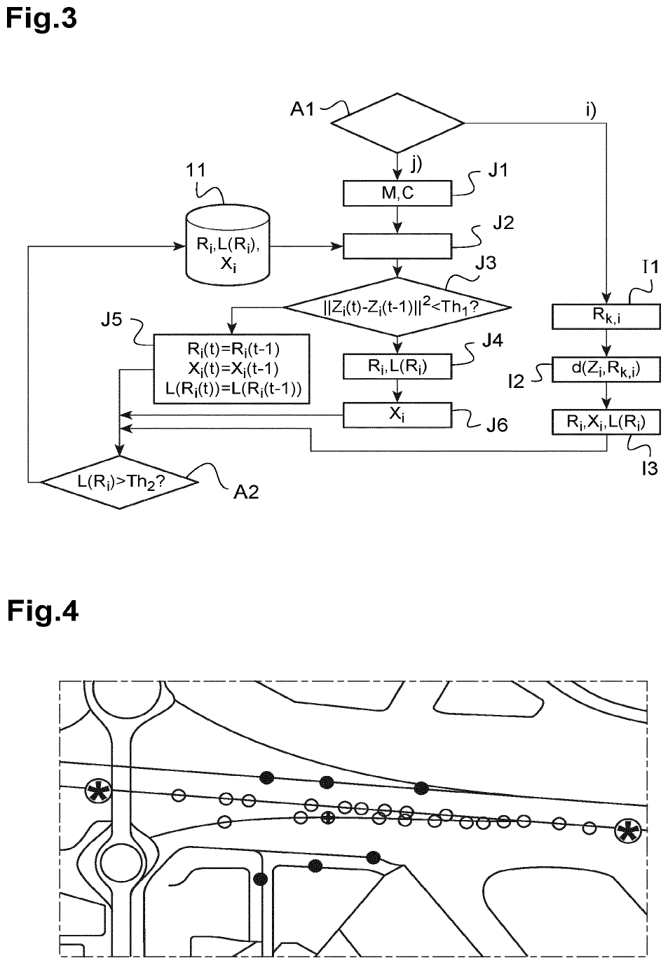

FIG. 3 is a diagram of the sub-steps included in step a) of the method according to the invention; and,

FIG. 4 is a schematic representation of an example of a map on which are shown all the information items received at a time t, namely selected information items, which will be transmitted to the on-board system, and information items not selected, which will not be transmitted to the on-board system.

FIG. 1 shows a device 10 for selecting information items from among a plurality of information items received at a time t from senders 100 located at distance from a vehicle 1, with a view to transmitting the selected information items to at least one driver assistance system located on board the vehicle 1. For the sake of simplification, the driver assistance system located on board the vehicle will be referred to in the rest of the description as the “on-board system 20, 21, 22”. The vehicle 1 is considered to intend to take a road network formed from traffic lanes, and the senders 100 are considered to be actors of this road network, for example, other vehicles, pieces of road infrastructure, or even users of the network such as pedestrians. The vehicle 1 and the senders 100 are all equipped with so-called “V2X” technology, by virtue of which they may send and receive messages containing information items. The traffic lanes are for example primary streets, minor highways, major highways and freeways, as well as pedestrian paths and cycle paths.

The received information items are for example the following information items: the absolute position (in GPS coordinates) of the sender, the reliability of this position, the speed of movement of the sender, the acceleration of the sender and/or its direction of movement, or even hazards that the sender has encountered or created during its movement (slippery road, dangerous bend, accident, traffic congestion, etc.).

Here, the vehicle 1 comprises, by way of on-board systems, a navigation system 20, which helps the driver to follow a route to get from point A to point B, an advanced driver assistance systems (ADAS) 21, and a dashboard 22, which displays alerts while the vehicle is being driven.

The device 10 is configured to communicate with each of the on-board systems 20, 21, 22 by means of wired or wireless communication, and preferably by means of wired communication.

Each on-board system 20, 21, 22 needs specific information items to operate accurately. However, it does not necessarily need all the information items received at the time t from all the senders 100. Thus, the on-board systems 20, 21, 22 indicate to the vehicle 1 the information items that they wish to see transmitted, potentially in terms of the nature of information items, in terms of the nature of the sender or, this being the subject of the invention, in terms of the position of the information items with respect to the vehicle 1.

The device 10 according to the invention is an intermediate filter between the senders 100 and the on-board systems 20, 21, 22, and is configured to spatially sort the information items received from the senders 100 so as to transmit to each on-board system 20, 21, 22 only the spatial information items that it wishes to see transmitted.

For example, the navigation system 20 is generally interested in information items that are relatively far from the vehicle 1, whereas information items that are located very close to the vehicle interest it less. For example, the presence of a traffic jam about 30 km in front of the vehicle 1 interests the navigation system 20. The dashboard 22 for its part prefers to use information items that are very close to the vehicle 1, whereas information items that are very far off are of little use to it. For example, information items located a few tens or up to a few hundred meters from the vehicle 1 are of interest to the dashboard 22, but not really information items located further away. The ADAS 21 uses both information items that are very close to the vehicle and information items that are located at an intermediate distance from the vehicle, but not information items that are located relatively far from the vehicle 1. For example, the ADAS 21 uses information items that are located up to a few kilometers from it, but no further. To give an order of magnitude, in an urban or peri-urban environment, an information item is considered to be close to the vehicle when it is located between 0 and 150 to 200 meters from the vehicle, i.e. in the field of visibility of conventional vehicle sensors 30, at an intermediate distance when it is comprised between 200 meters and 1 to 2 kilometers from the vehicle, and far off when it is located more than 2 kilometers away. It must be understood that these orders of magnitude of distance depend on the topology of the road and on the speed of the vehicle. When the vehicle is driving on a freeway at 130 km/h, these orders of magnitude must be increased. In any case, these orders of magnitude must not be considered to be limiting in the context of the invention.

The information items sent by the senders 100 are received, by the vehicle 1, and especially by the device 10, via relatively long-range wireless communication, and for example via radio waves.

As shown in FIG. 1, the device 10 according to the invention comprises: —a memory unit 11 configured to store a map of traffic lanes, at least one place of interest in which the information items to be transmitted to the on-board system 20, 21, 22 must be positioned, and the absolute position Zi of the i^{th} information item received at the time t, and
a control unit 12 configured to estimate the position of each received information item received from the senders 100 on the map and to select the information items to be transmitted to the on-board system 20, 21, 22 depending on the estimated position Xi of said information items in the map, and on the place of interest stored in the memory unit 11.

As shown in FIG. 1, the memory unit 11 is configured to communicate with the control unit 12. This communication is wired communication, or wireless communication. Preferably, the memory unit 11 and the control unit 12 are located on board the vehicle 1, and communicate via wired communication.

The control unit 12 comprises at least one computer configured to perform computations.

As shown in FIG. 1, the device 10 according to the invention is further configured to communicate with at least one sensor 30 of the vehicle, with a view to retrieving certain information items directly concerning the vehicle 1, and especially what will be referred to below as the ‘driving scenario’ of the vehicle.

For example, the device 10 is here configured to communicate with the GPS sensor of the vehicle, which delivers the absolute position of the vehicle 1, or even with the speed sensor, which gives the speed of the vehicle 1. Again for example, the device 10 is also configured to communicate with the on-board navigation system 20 (the navigation system 20 then being considered to be a sensor) which gives a reference route of the vehicle, i.e. an actual route taken by the vehicle 1 at the time t or a most probable route that the vehicle 1 is liable to take at the time t. The way in which the navigation system 20 determines the most probable route does not form part of the invention and will not be described in detail. When the navigation system 20 is not turned on, the device 10 is for example configured to communicate with a computer (by way of sensor) that is configured to compute the reference route of the vehicle in the form of the most probable route that the vehicle 1 is liable to take at the time t. The most probable route that the vehicle 1 is liable to take is in this case defined in a statistical manner and recomputed each time the vehicle is used. The way in which the computer computes this route is known per se and does not form part of the invention.

Moreover, the device 10 is configured to implement a method according to the invention, the main steps of which have been shown in the diagram of FIG. 2.

More precisely, the device 10 is configured to implement a method for selecting information items from among a plurality of information items received, at a time t, from senders 100 located at distance from the vehicle 1, with a view to transmitting the selected information items to at least one of the on-board systems in which method provision is made to:
a) estimate the position Xi of each received information item in the traffic-lane map stored in the memory unit 11, depending on the absolute position Zi of said information item received at the time t (block E1 of FIG. 2),
b) determine at least one place of interest in which the information items that said at least one on-board system 20, 21, 22 wishes to see transmitted must be positioned (block E2 of FIG. 2), and
c) select, among the received information items, those to be transmitted to the on-board system 20, 21, 22, depending on their estimated position Xi in the map established in step a) and on the place of interest determined in step b) (block E3 of FIG. 2).

Steps a), b) and c) are more particularly implemented by the control unit 12 of the device 10.

In practice, steps a) and b) may be implemented independently and in parallel with each other, while step c) is necessarily implemented after said steps a) and b).

In step b), the control unit 12 receives, on the one hand, from each on-board system 20, 21, 22, a wish list which defines a place of interest, and, on the other hand, from the sensors 30 of the vehicle 1, data on the driving scenario of the vehicle.

The driving scenario includes, for example, one or more of the following parameters: the speed of the vehicle, external weather conditions, whether the vehicle is driving through an urban environment or on a freeway, the reference route of the vehicle, traffic density, the speed limit, the number and nature of the physical sensors present in the vehicle, and the complexity of the network of traffic lanes at the time t.

The place of interest reflects the wish of the on-board system 20, 21, 22 to receive or not certain information items as a priority, depending on their spatial origin.

For example, the ADAS 21 may indicate to the control unit 12 that it wishes to always receive all the information items located within a radius of 200 meters around the vehicle 1 if the vehicle is traveling at less than 70 km/h, and all the information items located within a radius of 700 meters around the vehicle if it is traveling above 70 km/h, it being understood that information items located within a radius of 400 meters will have priority over any others. The ADAS 21 may add other conditions, for example that it wishes to obtain all the information items originating from the lanes adjacent to the traffic lane of the reference route taken by the vehicle 1, but only when the vehicle is in an urban environment. The ADAS 21 may further configure the size of the radius of the place of interest in which it wishes to receive information items depending on the weather conditions. For example, the ADAS 21 may indicate that, in the event of bad weather conditions, it wishes to increase the radius of the place of interest from which the information items must originate.

Each of the other on-board systems 20, 22 thus indicates its conditions to the control unit 12 of the device 10, and hence the control unit 12 knows all the criteria that it must take into account to establish the place of interest from which an information item must originate to be able to be transmitted to said on-board system 21, 22.

The control unit 12 then determines, for each on-board system 20, 21, 22, on the basis of the place of interest and of the driving scenario of the vehicle 1, a spatial filter that concretely delineates, in the space surrounding the vehicle 1, the wishes of said on-board system 20, 21, 22. In practice, the spatial filter indicates the traffic-lane portions of the map about which the on-board system 20, 21, 22 wishes to receive information items.

The spatial filter depends, on the one hand, on the position of the vehicle at a time t, and, on the other hand, on the reference route of the vehicle at the time t, i.e. on the actual route or the most probable route being taken by the vehicle 1 at the time t, this route for example being given by the navigation system 20.

The position of the vehicle 1 is either the absolute position of the vehicle 1—given in latitude, longitude and altitude—or the estimated position of the vehicle in the map, which position is obtained from the absolute position of the vehicle 1. Here, the absolute position of the vehicle 1 at the time t and the reference route of the vehicle 1 are delivered by the GPS sensor 30 and the navigation system 20, respectively. As a variant, the reference route of the vehicle could be given by the computer.

According to a first variant of embodiment, called the “explicit” variant, the map is defined as a set of traffic-lane segments and of nodes. Each segment, identified by an index idx, represents a traffic-lane portion or section without any intersection and may be any size. Each node represents an intersection between one or more traffic lanes. Thus, two segments of different index idx are separated by a node.

According to this first variant, the spatial filter that delineates the place of interest at each time t comprises a subset of traffic-lane segments and of nodes.

According to a second variant of embodiment, called the “implicit” variant, the spatial filter comprises:
a reference position in the map, which is in general the position of the vehicle 1,
a maximum distance on the reference route of the vehicle 1, measured from the reference position,
the degree of adjacent traffic lanes to be considered, and
possibly, a maximum distance, in the adjacent traffic lanes, measured from the reference position.

The traffic lanes adjacent to the reference route are considered to be those that intercept this reference route, directly or indirectly. A first-degree adjacent traffic lane corresponds to a traffic lane that directly intersects the reference route, whereas a second-degree adjacent traffic lane is a traffic lane that intersects a first-degree adjacent traffic lane. In other words, any traffic lane that leaves the reference route is a first-degree adjacent traffic lane; and any traffic lane that leaves a first-degree adjacent traffic lane is a second-degree adjacent traffic lane.

From these implicit information items, the control unit 12 is able to determine which traffic-lane sections are of interest to the on-board system 20, 21, 22.

Whatever the variant envisioned, the spatial filter changes over time, on the one hand because the driving scenario changes, and, on the other hand, because the vehicle 1 moves.

Thus, the control unit 12 checks very regularly whether the spatial filter is adequate given the driving scenario of the vehicle and the position of the vehicle 1.

Preferably, the control unit 12 determines, in step b), not a single spatial filter, but a set F of spatial filters that correspond to the driving scenario of the vehicle 1 over the entirety of the journey of the vehicle, each spatial filter being associated with part of the reference route of the vehicle 1.

Provision is also made for the memory unit 11 to have in memory a plurality of sets Fx of spatial filters, each set Fx corresponding to certain recurrent journeys of the vehicle, or to certain hours of the day for example.

This makes it easier for the control unit 12 to determine the spatial filter at the time t, since the control unit 12 is then able to choose the spatial filter corresponding to one part of the journey of the vehicle from among the set Fx of spatial filters in memory, said set being associated with the overall journey taken by the vehicle 1.

The control unit 12 also checks whether the set F of spatial filters associated with the entire journey is adequate or whether it needs to be changed. This verification is for example carried out very regularly or only in the event of a modification of the journey of the vehicle with respect to the reference route.

Each set of spatial filters is stored and updated in the memory unit 11 based on the history of the journeys of the vehicle, and/or on a learning method that especially takes into account the likelihood of each spatial filter.

At the end of step b), the control unit 12 therefore knows, in the form of a spatial filter or of a set of spatial filters, the geographical locations from which the information items that each on-board system will process must originate.

For its part, step a) consists in locating the information item received at the time t by the vehicle 1, this locating operation for the most part having two stages:
it is first necessary to select, from among a plurality of possible traffic-lane sections, the best candidate, i.e. the most likely traffic-lane section from which the received information item is liable to have originated, then
once the best candidate has been found among the possible traffic lanes, it is necessary to project the absolute position Zi of the received information item onto this traffic-lane section, in order to determine the estimated position Xi of the information item in the map.

Step a) of the method according to the invention will now be explained in more detail with reference to FIG. 3, which gives an overview of the main sub-steps comprised therein.

During a selecting first sub-step, represented by block A1 of FIG. 3, provision is made to:
choose the location procedure that will be implemented by the control unit 12 to select the best candidate from among the possible traffic-lane sections, then to
locate the information item received at the time t on this traffic-lane section.

More precisely, for each information item received at the time t, the control unit 12 chooses the location procedure to be implemented from among a simplified location procedure with rapid execution (path i in FIG. 3) or a complex location procedure with slower execution (path j in FIG. 3). The choice is made depending on a density value of the network of traffic lanes along the reference route taken by the vehicle 1.

The density value of the network of traffic lanes (or road network) here corresponds to the total length of the traffic lanes in a given area. This density value is given in TR/m². The density value is evaluated for a relatively large area, the size of which depends on the driving scenario. The density value is for example evaluated on the basis of the map and/or on the basis of the number of intersections (nodes) between various traffic-lane sections in the given area of the map. This density value gives an indication of the complexity of the road network. A low value corresponds to a road network that is not very complex, for example to a rural region, whereas a high value corresponds to a complex road network, for example to a city-center region. A priori, the more complex the road network the more difficult the information item will be to locate, insofar as the information item is liable to have originated from a high number of distinct traffic-lane sections that are close to one another.

Consequently, when the density value is higher than a predetermined maximum threshold value, the control unit 12 is programmed to choose the location procedure referred to as the complex location procedure (path j of FIG. 3). This procedure, which is more resource-intensive computationally and therefore slower, is privileged with a view to maximizing the accuracy and reliability of the localization when there are many candidate traffic-lane sections. In contrast, when the density value is lower than a predetermined minimum threshold value, the control unit 12 is programmed to choose the location procedure referred to as the simplified location procedure (path i of FIG. 3). The simplified procedure is less resource-intensive computationally and therefore faster to execute.

The choice of the location procedure is further made depending on a statistical error associated with the absolute position Zi of the information item received at the time t.

In particular, when the density value is comprised between said minimum and maximum threshold values, the control unit 12 uses a confidence ring associated with the absolute position Zi to choose which of the simplified and complex location procedures must be implemented.

In practice, each received information item is associated with an absolute position Zi, delivered by the GPS of the sender 100 that transmitted the information item. This absolute position Zi is given in terms of latitude, longitude and altitude. The sender 100 of the received information item gives the absolute position Zi with a relatively high or low reliability. Thus, the absolute position Zi is associated with a confidence ring, which is generally ellipse shaped, and which represents the variance of the error. The larger the confidence ring, the lower the reliability of the absolute position Zi, and therefore the higher the statistical error associated with said absolute position Zi. In contrast, the smaller the confidence ring, the higher the reliability of the absolute position Zi, and therefore the lower the statistical error associated with the absolute position Zi.

When the density value is comprised between said minimum and maximum threshold values, the control unit 12 compares the statistical error associated with the absolute position Zi with a predetermined minimum error value. When the statistical error associated with the absolute position Zi is lower than said minimum error value, the control unit 12 opts for the simplified location procedure (path i in FIG. 3). In contrast, when the statistical error associated with the absolute position Zi is higher than said minimum error value, the control unit 12 opts for the complex location procedure (path j in FIG. 3). Here, the statistical error associated with the absolute position Zi of the i^{th} information item is considered to depend on the confidence ring described above. For example, the statistical error is the variance of the set of all the positions included in the confidence ring, or indeed the standard deviation of the set of all the positions included in the confidence ring.

In practice, the complex location procedure is particularly suitable for dynamically locating information items, i.e. for locating information items that move over time, whereas the simplified location procedure may prove to be sufficient in the context of static information items.

When the simplified location procedure is chosen by the control unit 12, path i of FIG. 3 is implemented.

The simplified location procedure comprises a first step (block 11 of FIG. 3) of retrieving data, during which the control unit 12 retrieves, from the memory unit 11, all the possible traffic-lane sections from which the information item is liable to have been sent.

In practice, in the first step (block 11), the control unit 12 determines the search region in which it will seek to locate the information item. According to a first variant, the control unit 12 then retrieves from the memory unit 11 all the traffic-lane sections comprised in the set F of spatial filters used, at the time t, in step b) of the method, and selects, from among these traffic-lane sections of the map, the k sections referenced Rk,i, that are relevant given the absolute position Zi of the received information item, and especially those that are located in the vicinity of the absolute position Zi.

According to a second variant of the first step (block 11), the control unit 12 retrieves all the traffic-lane sections Rk,i comprised in the spatial filters of the set F of spatial filters used in step b). According to this second variant, the search region then comprises all the traffic-lane sections Rk,i of the vehicle journey.

Whichever variant it is envisioned to use to implement the first step (block 11), each traffic-lane section Rk,i is mathematically defined as a segment, described by a linear equation with coefficients −a/b and −c/b.

The start point Sk,i and end point Ek,i of the segment Rk,i are described by (Sk,i; Ek,i)∈Rk,i.

The simplified location procedure then comprises a step (block 12 of FIG. 3) of orthogonal projection, during which the control unit 12 performs an operation of orthogonal projection of the absolute position Zi of the received information item into each traffic-lane section Rk,i retrieved in the preceding step (11).

The control unit 12 then computes the distance d(Zi, Rk,i) between the absolute position Zi and its orthogonal projection onto the traffic lane Rk,i, by implementing the following computation.

$$d ( {Z}_{i} , {R}_{k , i} ) = \frac{( a + b + c )}{\sqrt{( {a}^{2} + {b}^{2}}} \qquad [ Math . 1 ]$$

The point of intersection between the segment Rk,i and the orthogonal projection of the absolute position Zi is found directly using a closed form. The point of intersection is called I_{k, i}.

T is the acceptable maximum distance between the absolute position Zi and its orthogonal projection, in respect of whether the traffic-lane section is to be considered a candidate to be retained. In other words, the traffic-lane section Rk,i is considered to be a possible candidate if and only if the following equation is respected.

f(Zᵢ,R_{k,i})=d(Zᵢ,R_{k,i})<TAND I_{k,i}∈(S_{k,i};E_{k,i})∀k,i [Math. 2]

The simplified location procedure lastly comprises a concluding step (block 13 of FIG. 3), during which the control unit 12 selects the best candidate from among the retained traffic-lane sections. In practice, the best candidate is the one that corresponds to the shortest orthogonal projection required to position the received information item on one of the traffic-lane sections of the map.

To select the best candidate traffic-lane section Ri as the one from which the information item having the absolute position Zi originated, the control unit 12 implements the following computation.

Rᵢ=argmin{R_{k,i}∈F} with f(Zᵢ,R_{k,i})<T [Math. 3]

The estimated position Xi of the information item in the map will then be

considered to be the obtained point of intersection lk,i between the traffic-lane section Ri and the orthogonal projection of the absolute position Zi onto this section Ri. In other words, the estimated position Xi of the information item in the map is the result of the shortest orthogonal projection onto the traffic-lane sections surrounding the absolute position Zi.

The control unit 12 then knows, with a reliability L(Ri), from which traffic-lane section Ri the received information item originated, and from which estimated position Xi, on said traffic-lane section Ri, said information item originated.

The reliability L(Ri) associated with the determination of the traffic lane Ri from which the information item originated is computed in a manner known per se. For example, this reliability L(Ri) may be given by two separate computations. According to the first computation, for each candidate traffic-lane section Ri,k,j the reliability L(Ri,k,j) is the ratio between the a posteriori probability that the estimated position Xi is on the section Ri,k,j given that the absolute position is Zi and the maximum of all the other probabilities computed for all the other candidate traffic-lane sections Ri,k,m with m different from j. According to the second computation, for each candidate traffic lane Ri,k,j, the reliability L(Ri,k,j) is the ratio between the a posteriori probability that the estimated position Xi is on the section Ri,k,j given that the absolute position is Zi and the average of all the other probabilities computed for all the other candidate traffic-lane sections Ri,k,m with m different from j.

In a last step of the simplified location method, represented by block A2 of FIG. 3, the reliability L(Ri) associated with the determination of the traffic lane from which the information item originated is compared with a predetermined reliability threshold value Th2. The predetermined reliability threshold value Th2 is higher than or equal to 0, this guaranteeing that one of the best candidate traffic-lane sections will be chosen. The predetermined reliability threshold value Th2 in practice depends on the size of the confidence ring associated with the absolute position Zi and on the size of the search region in which it is sought to locate the information item.

If the reliability L(Ri) is higher than the predetermined reliability threshold value Th2, the memory unit 11 records that the information item received at the time t originated from the traffic lane Ri, with a reliability L(Ri), and that the information item is more specifically located at the estimated position Xi of the map at this time t. Thus, in the memory unit 11, are associated, with the time t and the received information item, the absolute position Zi, the estimated position Xi, the traffic-lane section Ri on which the sender 100 of the information item is located, and the reliability L(Ri).

By convention, and unless otherwise indicated, it must be understood that the notations Xi, Zi, Ri, L(Ri) used in the text correspond to the parameters at the time t, and are equivalent to the notations Xi(t), Zi(t), Ri(t), L(Ri(t)).

When the complex location procedure is chosen by the control unit 12, path j of FIG. 3 is implemented. The complex location procedure uses an algorithm known per se called the hidden Markov model (HMM), but comprises preliminary steps before implementation of this algorithm that allow computation time to be optimized without decreasing the reliability of the result, or at the very least while minimizing loss of reliability.

This algorithm is capable of delivering the best traffic-lane section on which the received information item is liable to be found, and the probability that the information item is actually found on this section. To find the best section, the control unit 12 uses the past positions of the information item (and the reliability of these positions) to estimate the most probable journey made by the information item. To arrive at the result, the algorithm attributes a probability to each candidate traffic-lane section, and a transition probability associated with passage of the information item from one candidate section at the time t-1 to another candidate section at the time t.

To find the traffic-lane section Ri on which the absolute position Zi of the information item received at the time t should be projected, the complex location procedure determines, on the one hand, a relatively extensive region of the map in which said section should be sought, and, on the other hand, a relatively high number of past positions adopted by the information item at times preceding the time t that should be considered to trace the journey of the information item.

In other words, the complex location procedure (path j in FIG. 3) comprises a parametrizing first sub-step (block J1 of FIG. 3), during which the control unit 12 determines, on the one hand, the region of the map in which all the candidate traffic-lane sections will be contained, and, on the other hand, the number of past positions adopted by the received information item at times preceding the time t that should be used to determine the best of the candidates.

Thus, during the parametrizing step, the control unit 12 parametrizes the size of the region of the map and the number of past positions to be considered in order to evaluate the best candidate.

The larger the region of the map in which the best candidate among all the traffic-lane sections of said region is sought, the higher the chance of finding the best candidate, but the higher the number of traffic-lane sections to be evaluated and therefore the longer the computation time. In practice, to parametrize the size of the search region, the control unit 12 sets a parameter C, which is a multiplicative factor by which the confidence ring associated with the absolute position Zi of the information item is multiplied. The search region will thus be equal to C times the confidence ring. The parameter C is at least equal to 2.

Using the past positions adopted by the information item, the control unit 12 is capable of tracing the course of the information item. By virtue of the HMM, the control unit 12 is capable of eliminating certain of the traffic-lane sections that were initially candidates, because the control unit 12 considers that it is almost impossible for the information item to originate from one of these traffic-lane sections. The higher the number of positions passed, the more accurate the course traced by the control unit 12, and therefore the higher the chances of finding the best candidate among all the possible sections. In practice, to parametrize the number of past positions that the control unit 12 must take into account, said control unit 12 sets a parameter M that corresponds to said number of past positions. The parameter M is at least equal to 2.

The parameters M and C are parametrized depending on the confidence ring associated with the absolute position Zi of the information item received at the time t. More precisely, the statistical error resulting from the confidence ring associated with the absolute position Zi is compared with a predetermined maximum error value. When the statistical error associated with the absolute position Zi is higher than said maximum error value, the control unit 12 preferably parametrizes a large search region in the map and a high number of past positions will be employed. For example, the control unit 12 sets the parameter C to be equal to 3 or 5, and the parameter M to be equal to 4, 6 or 10. When the statistical error associated with the absolute position Zi is lower than said maximum error value, the control unit 12 preferably parametrizes a smaller search region and a lower number of past positions will be employed. For example, the control unit 12 sets the parameter C to be equal to 2 or 3, and the parameter M to be equal to 2 or 4. According to one envisionable variant, the parameters C and M may also be uncorrelated from each other so that the control unit 12 may parametrize a high number of past positions and a small search region, or vice versa. The parametrization of the parameters M and C nevertheless still depends on the confidence ring associated with the absolute position Zi delivered by the GPS of the sender 100 of the information item, and on the comparison of the statistical error resulting from this confidence ring with the predetermined maximum error value.

The complex location procedure (path j of FIG. 3) further comprises an initializing step (block J2 of FIG. 3), during which it is chosen, for each of the past positions adopted at one of the times preceding the time t, whether said position to be considered is the absolute position Zi or the estimated position Xi in the map of the information item received at said time preceding the time t, the choice being made depending on the reliability associated with each of said absolute or estimated positions Zi or Xi.

More precisely, it is the absolute position Zi or estimated position Xi with the best reliability that is retained as the position of the information item received at the time preceding the time t. Thus, when the reliability L(Ri) associated with the estimated position Xi is close to zero (or lower than a predetermined threshold value), the absolute position Zi is the position retained for the i^{th} information item received at the time preceding the time t, whereas when the reliability L(Ri) associated with the estimated position Xi is high (higher than the predetermined threshold value), then the estimated position Xi is the position retained for the i^{th} information item received at the time preceding the time t.

In practice, the reliability associated with the estimated position Xi is computed at the end of the method (block J4 of FIG. 3), as will be described in detail below.

The initializing step (block J2) allows the speed of execution of the method to be increased by decreasing complexity and the number of computations, since results obtained at preceding times will potentially be reused when they are relevant.

The initializing step J2 is implemented after the parametrizing step J1.

The complex location method then comprises a step (block J3 of FIG. 3) that consists in evaluating whether the information item has remained static between the times t−1 and t at which it was sent.

To do this, at the step of block J3, the absolute positions Zi(t) and Zi(t−1) of the information item are compared.

More precisely, the control unit 12 compares the distance between said absolute positions Zi(t) and Zi(t−1) with a threshold value Th1. If the distance between said absolute positions is smaller than said threshold value Th1, then the control unit 12 considers the information item not to have moved.

In practice, the distance between said absolute positions is computed via:

∥Zᵢ(t)−Zᵢ(t−1)∥² [Math. 4]

In doing so, the control unit 12 avoids unnecessary computations and directly retrieves the computations performed at the time t−1.

If the information item is considered by the control unit 12 not to have moved or to have moved little, then, in the step represented by block J5 in FIG. 3, the control unit 12 determines that the traffic-lane section Ri(t) on which the sender is located at the time t is identical to the traffic-lane section Ri(t−1) on which the sender was located at the time t−1, that the reliability L(Ri(t)) of the traffic-lane section elected as the best candidate at the time t is equal to the reliability L(Ri(t−1)) of the traffic-lane section elected as the best candidate at the time t−1, and that the estimated position Xi(t) of the information item received at the time t is equal to the estimated position Xi(t−1) of the information item received at the time t−1. This is expressed by:

Rᵢ(t)=Rᵢ(t−1);L(Rᵢ(t))=L(Rᵢ(t−1));Xᵢ(t)=Xᵢ(t−1) [Math. 5]

In contrast, if the distance between said absolute positions is larger than said threshold value Th1, then the control unit implements the HMM (it will be recalled that HMM stands for hidden Markov model).

In the step of block J4, the HMM algorithm delivers the best traffic-lane section on which the received information item is liable to be found, and the probability Prob(Rk,i|Z) that the information item is actually found on this section. As explained above, to find the best section, the control unit 12 uses the past positions of the information item (and the reliability of these positions) to estimate the most probable journey made by the information item. The HMM attributes a probability to each candidate traffic-lane section, and a transition probability associated with passage of the information item between a candidate section at the time t−1 and a candidate section at the time t. In practice, the HMM computes the probability that the received information item is actually found on the section, depending on:
a distance (a Euclidean distance or one based on a great circle), and
the transition probability.

The expression describing the transition probabilities may be found in the literature and is known per se.

The algorithm thus establishes the sequence of candidate sections that best represents the movement of the information item.

Two effects, probable error and false alarm, must be minimized to obtain the highest possible confidence in the obtained result.

Probable error p(errorᵢ) is defined as the probability that the absolute position Zi of the information item will not be positioned on the correct traffic-lane section Rk,i by the algorithm when it in fact originates from said section Rk,i. Mathematically, probable error is written as follows.

p(errorᵢ)=p(R̅_{ι}|Xᵢ∈Rᵢ) [Math. 6]

False alarm Pfalse is defined as the probability that the absolute position Zi of the received information item will be associated by the algorithm with the traffic-lane section Ri when it in fact originates from another traffic-lane section Rk,i. Mathematically, false alarm is written as follows.

p_{False}=p(r_{k,i}|xᵢ∉r_{k,i}) [Math 7]

In the step of block J4, the control unit 12 implements a series of computations to estimate the reliability of the result output by the algorithm.

The reliability estimate indicates the algorithm's confidence that it has associated the information item with the correct traffic-lane section.

The reliability L(Ri) is measured using the following equation.

$$L ( {R}_{k , i} ) = log \frac{Prob ( {R}_{k , i} \vert Z )}{{E}_{\{ j \neq k \}} [ Prob ( {R}_{j , i} \vert Z ) ]} \qquad [ Math 8 ]$$

The higher the reliability L(Rk,i), the higher the chances that at the end of the algorithm the best candidate among the possible traffic-lane sections Rk,i will have been found. Thus, the best candidate section Rk,i is the one associated with the highest reliability L(Rk,i).

In a following step, represented by block J6 in FIG. 3, the control unit determines the estimated position Xi of the i^{th} information item received at the time t, in the map. To do this, knowing the traffic-lane section Ri from which the information item originated (this section having been elected from among all the sections Rk,i), the control unit 12 projects the absolute position Zi onto the section Ri orthogonally.

In a last step, which is identical to the step described in detail in the context of the simplified location procedure, the control unit 12 estimates whether it is necessary to implement, in the memory unit 11, the new “data” obtained for the information item received at the time t, namely the traffic-lane section Ri(t) on which the sender 100 of the information item is located, the reliability L(Ri(t)) of the determination of this section and the estimated position Xi(t) of the information item on the section (block A2 of FIG. 3).

By virtue of step a) of the method, the information items are located with greater accuracy and at a lower cost.

In step c), the method according to the invention combines the results of steps a) and b). Thus, all the received information items having been located on the map in step a), and the spatial filter associated with each on-board system 20, 21, 22 being known from step b), the control unit 12 checks which received information items are located on traffic-lane sections located inside the spatial filter in order to dispatch only these information items to the on-board system 20, 21, 22.

If the received information item is located on a traffic-lane section located outside the spatial filter, it is not transmitted to the on-board system 20, 21, 22. In contrast, if the received information item is located on a traffic-lane section located in the spatial filter, this information item is transmitted to the on-board system 20, 21, 22, which will be able to process it.

FIG. 4 gives one example of a map on which all of the information items received by the device 10 has been shown. The location of the vehicle 1 has been marked by a cross. The information items have been represented by empty circles, solid circles, or circles filled with an asterisk. In practice, only the information items represented by the empty circles are here transmitted to one of the on-board systems 20, 21, 22, the information items represented by the solid circles being located on traffic lanes that never intersect the traffic lane of the most probable route taken by the vehicle, whereas the information items represented by the circles filled with an asterisk are located too far from the vehicle to be of interest to the on-board system 20, 21, 22.

The present invention is in no way limited to the embodiments that have been described and shown, implementation of any variant according to the invention being within the ability of those skilled in the art.

It is especially envisionable for the vehicle 1 to comprise a processing unit configured to sort the information items received from the senders 100 depending on their nature and/or on the type of sender 100 that sent them. For example, the processing unit is placed upstream of the device according to the invention, so that the device according to the invention receives only information items the nature of which is liable to be of interest to at least one of the on-board systems of the vehicle 1. If the device according to the invention is placed upstream of the processing unit, this being entirely envisionable, the device spatially identifies all the received information items before they are filtered depending on their nature or the nature of their sender. The communication between the filter and the device according to the invention is preferably wired communication.

According to another envisionable variant, in step c), information items that are located on traffic-lane sections located outside of the spatial filter may be transmitted to the on-board system with an indication that they must be processed less urgently than the other information items, rather than not being transmitted to the on-board system at all. Thus, it is possible by virtue of the invention to classify the received information items in order of priority and of importance, depending on their location on the map.

1-10. (canceled)

11. A method for selecting information items from among a plurality of information items received at a time t from senders located at distance from a vehicle, in order to transmit the selected information items to at least one driver assistance system located on board the vehicle, the method comprising:
a) estimating a position of each received information item in a traffic-lane map depending on an absolute position of said information item received at the time t,
b) determining at least one place of interest in which the information items that said at least one on-board system is configured to see transmitted as a priority must be positioned,
c) selecting, among the received information items, the information items to be transmitted to the on-board system, depending on the estimated position on the map established in a) and on the place of interest determined in b),
wherein, in a), the position of each information item received at the time t is estimated in the map using a location procedure chosen from among a simplified procedure with rapid execution or a complex procedure with slower execution, which location procedure is chosen depending on a density value of the network of traffic lanes along the route taken.

12. The method as claimed in claim 11, wherein the choice of the location procedure is further made depending on a statistical error associated with the absolute position of the information item received at the time t.

13. The method as claimed in claim 11, wherein the simplified procedure comprises an orthogonal projection of the absolute position of the received information item into each traffic lane, and selection of the shortest orthogonal projection to position the received information item in the map.

14. The method as claimed in claim 11, wherein the complex location procedure determines the traffic lane into which it is appropriate to project the absolute position of the information item received at the time t, based on a relatively extensive region of the map and a relatively high number of past positions adopted by the information item received at times preceding the time t.

15. The method as claimed in claim 14, wherein the complex location procedure comprises parametrizing a size of the region of the map and the number of past positions to be considered, depending on a statistical error associated with the absolute position of the information item received at the time t.

16. The method as claimed in claim 14, wherein the complex location procedure further comprises initializing, which includes choosing, for each of the past positions adopted at one of the times preceding the time t, whether said position to be considered is the absolute position or the estimated position in the map of the information item received at said time preceding the time t, the choice being made depending on a reliability associated with the estimated position.

17. The method as claimed in claim 11, wherein, in b), the place of interest is delineated by a spatial filter which indicates a traffic-lane portions to be considered depending on a position of the vehicle at the time t and on a reference route of the vehicle at the time t.

18. The method as claimed in claim 17, wherein the spatial filter comprises a subset of traffic-lane segments and of nodes.

19. The method as claimed in claim 17, wherein the spatial filter comprises:
a reference position in the map,
a maximum distance on the reference route of the vehicle, measured from the reference position, and
a degree of adjacent traffic lanes to be considered.

20. The method as claimed in claim 19, wherein the spatial filter comprises:
a maximum distance, in the adjacent traffic lanes, measured from the reference position.

21. A device for selecting information items from among a plurality of information items received at a time t from senders located at distance from a vehicle, configured to transmit the selected information items to a driver assistance system located on board the vehicle, the device comprising:
a memory unit configured to store a map of traffic lanes, at least one place of interest in which the information items to be transmitted as a priority to the on-board system must be positioned, and an absolute position of the information item received at the time t, and
a control unit configured to estimate the position of each received information item in the map and to select the received information items to be transmitted as a priority to the on-board system depending on the estimated position of said received information items, in the map, and on the place of interest stored in the memory unit,
wherein said control unit is configured to estimate the position of each received information item, in the map, using a location procedure chosen from among a simplified procedure with rapid execution or a complex procedure with slower execution, which location procedure is chosen depending on a density value of the network of traffic lanes along the route taken.
